(19) United States
(12) Patent Application Publication
(10) Pub. No.: US 2013/0019059 A1
(43) Pub. Date: Jan. 17, 2013

(54) HARD DISK DRIVE ADAPTER

(71) Applicants: WEN-SEN HU, Shenzhen City (CN); WEI-MIN HE, Shenzhen City (CN)

(72) Inventors: WEN-SEN HU, Shenzhen City (CN); WEI-MIN HE, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/277,236

(22) Filed: Oct. 20, 2011

(30) Foreign Application Priority Data
Jul. 15, 2011 (CN) 201110198121.8

(51) Int. Cl. G06F 12/00

(52) U.S. Cl. 711/112; 711/E12.001

(57) ABSTRACT

A hard disk drive (HDD) adapter includes a first connector, a second connector, and a signal reproduction circuit. The first connector is electrically connected to a motherboard of a computer server. The second connector is electrically connected to a number of hard disk drive (HDD) drives. The signal reproduction circuit is electrically connected to the first connector and the second connector, and reproduces a signal from the motherboard into a number of signals provided to the HDD drives.

### BACKGROUND

1. Technical Field

The present disclosure relates to a hard disk drive (HDD) adapter.

2. Description of Related Art

A computer server only includes a limited number of hard disk drive interfaces, for example, Peripheral Component Interconnect-Express (PCIE) slots. Thus, the number of the hard disk drive (HDD) drives that can be connected to the computer server is limited.

Therefore, it is desirable to provide a HDD adapter that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a HDD adapter, according to an exemplary embodiment.

FIG. 2 is a functional diagram of the HDD adapter of FIG. 1.

### DETAILED DESCRIPTION

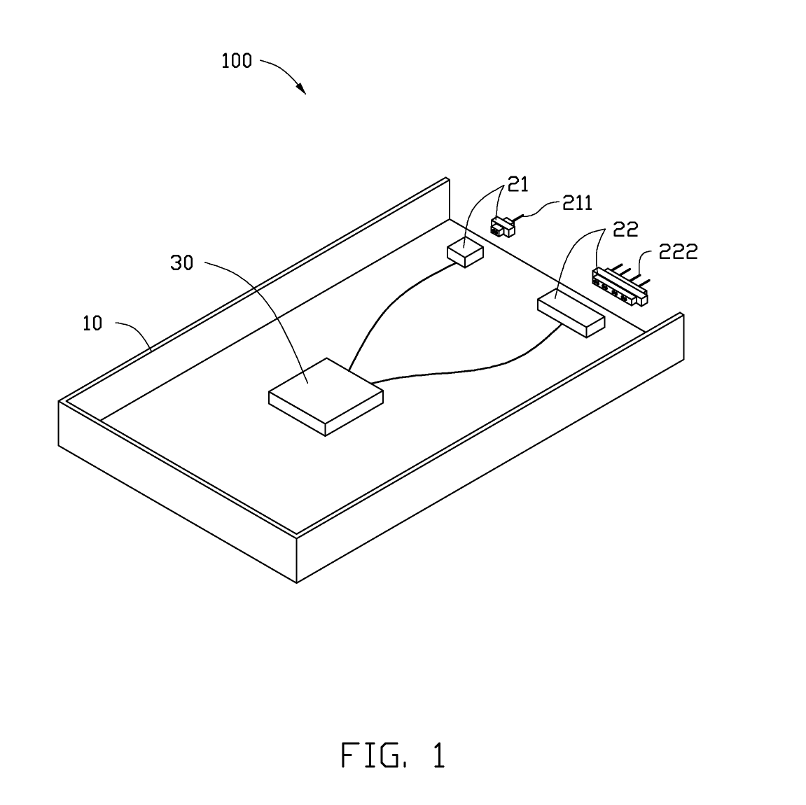

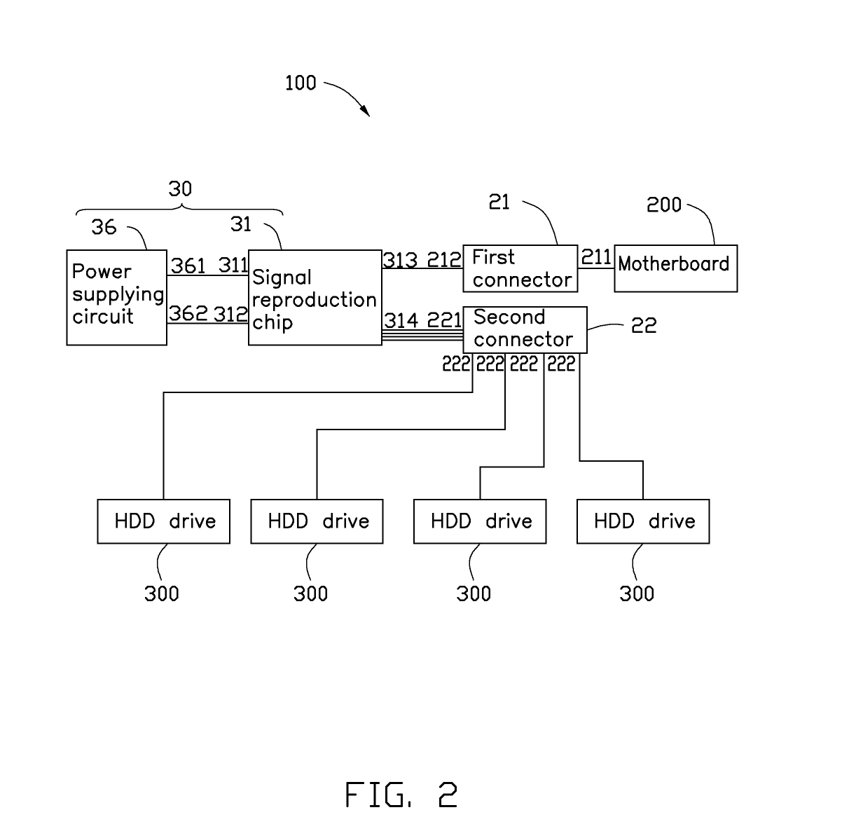

Referring to FIG. 1 and FIG. 2, a HDD adapter 100, according to an embodiment, is electrically connects to a motherboard 200 of a computer server (not shown) and a number of HDD drives 300. The adapter 100 includes a shell 10, a first connector 21, a second connector 22, and a signal reproduction circuit 30.

The shape and the volume of the shell 10 are approximately same as the shape and the volume of the HDD drives 300, and thus the shell 10 can be fixed on a bracket (not shown), which fixes the HDD drives 300 in the computer server.

The first connector 21 has a first input pin 211 and a first output pin 212. The first input pin 211 is electrically connected to the motherboard 200. The second connector 22 includes a second input pin 221 and four second output pins 222. Each second output pin 222 is electrically connected to a corresponding HDD drive 300. The first connector 21 and the second connector 22 are received in the shell 10. The first input pin 211 and the four second output pins 222 can extend outwards from the shell 10. The first connector 21 and the second connector 22 are compatible with a signal the HDD drive 300 uses. In one embodiment, the HDD drive 300 transmits SATA signals. The number of the second output pins 222 is not limited to this embodiment.

The signal reproduction circuit 30 is received in the shell 10 and includes a signal reproduction chip 31 and a power supply circuit 36. The signal reproduction chip 31 is used for reproducing a signal from the motherboard 200 into four signals and includes a first power input terminal 311, a second power input terminal 312, a signal input terminal 313, and four signal output terminals 314. The signal input terminal 313 is electrically connected to the first output pin 212. The four signal output terminals 314 are electrically connected to the four second input pins 221 respectively. The number of the signal output terminals 314 is equal to the number of the reproduced signals, and is not limited to this embodiment.

The power supply circuit 36 includes a first power output terminal 361 and a second power output terminal 362. The first power output terminal 361 and the second power output terminal 362 are used for providing two different voltages to the signal reproduction chip 31 respectively. The first power output terminal 361 is electrically connected to the first power input terminal 311. The second power output terminal 362 is electrically connected to the second power input terminal 312.

In one embodiment, the output voltage of the first power output terminal 361 is about 1.8V, and the output voltage of the second power output terminal 362 is about 3.3V. The signal reproduction chip 31 can be a Si13726CBHU chip.

In other embodiments, each second output pin 222 can be electrically connected to another signal reproduction circuit, and thus to obtain more signals to allow the motherboard 200 to electrically connect to more HDD drives 300.

The HDD adapter 100 can connect more HDD drives 300 to the motherboard 200 and does not need to occupy the PCIE slot.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A hard disk drive (HDD) adapter comprising:
a first connector electrically connected to a motherboard of a computer server,
a second connector electrically connected to a plurality of HDD drives, and
a signal reproduction circuit electrically connected to the first connector and the second connector, and configured for reproducing a signal from the motherboard into a plurality of signals provided to the HDD drives.

2. The HDD adapter of claim 1, wherein the HDD adapter further comprises a shell, the first connector, the second connector, and the signal reproduction circuit are received in the shell.

3. The HDD adapter of claim 2, wherein shape and volume of the shell are approximately same as shape and volume of the HDD drives.

4. The HDD adapter of claim 1, wherein the signal reproduction circuit comprises a signal reproduction chip, the signal reproduction chip comprises a signal input terminal and a plurality of signal output terminals, the first connector comprises a first input pin and a first output pin, the first input pin is electrically connected to the motherboard, the first output pin is electrically connected to the signal input terminal, the second connector comprises a plurality of second input pins and a plurality of second output pins, the second input pins are electrically connected to the signal output terminals respectively, the second output pins are electrically connected to a corresponding HDD drive.

5. The HDD adapter of claim 4, wherein the signal reproduction circuit further comprises a power supplying circuit for providing power to the signal reproduction chip.

6. The HDD adapter of claim 4, wherein the signal reproduction chip is a Si13726CBHU chip.
